(19) United States
(12) Patent Application Publication
(10) Pub. No.: US 2013/0026763 A1
(43) Pub. Date: Jan. 31, 2013

(54) WIND POWER EXCITATION SYNCHRONOUS GENERATION SYSTEM AND CONTROL METHOD THEREOF

(71) Applicants: TZUEN-LIH CHERN, Kaohsiung City (TW); Der-Min Tsay, Kaohsiung City (TW); Jao-Hwa Kuang, Kaohsiung City (TW); Guan-Shyong Hwang, Kaohsiung City (TW); Li-Hsiang Liu, Kaohsiung City (TW); Wei-Ting Chen, Kaohsiung City (TW); Ping-Lung P. Pan, Kaohsiung City (TW); Tsung-Mou Huang, Kaohsiung City (TW)

(72) Inventors: TZUEN-LIH CHERN, Kaohsiung City (TW); Der-Min Tsay, Kaohsiung City (TW); Jao-Hwa Kuang, Kaohsiung City (TW); Guan-Shyong Hwang, Kaohsiung City (TW); Li-Hsiang Liu, Kaohsiung City (TW); Wei-Ting Chen, Kaohsiung City (TW); Ping-Lung P. Pan, Kaohsiung City (TW); Tsung-Mou Huang, Kaohsiung City (TW)

(73) Assignee: National Sun Yat-Sen University, Kaohsiung City (TW)

(21) Appl. No.: 13/345,706

(22) Filed: Jan. 7, 2012

(30) Foreign Application Priority Data
Jul. 29, 2011 (TW) 100127128

(51) Int. Cl. H02P 9/04

(52) U.S. Cl. 290/55

(57) ABSTRACT

A wind power excitation synchronous generation system and a control method thereof are disclosed. In this control method, dual input shafts and a single output shaft of a gear transmission mechanism are used, and two kinds of inputted energy, such as wind energy and servo motor control power, are integrated, so as to allow the output shaft to drive an excitation synchronous generator to generate electric power. In this system, a rotation speed and a phase of a servo motor are controlled, so as to allow the excitation synchronous generator to output the electric power with a frequency and a phase identical to the utility grid. Furthermore, a control circuit for maximum power tracking is used to control an excitation current of the excitation synchronous generator for achieving a stable voltage, the maximum outputted wind energy and the minimum energy consumption of the servo motor.

### FIELD OF THE INVENTION

The present invention relates to a wind power excitation synchronous generation system and a control method thereof, and more particularly, to a control method for driving the generator at a constant speed, stable voltage, frequency, and a phase equal to the utility grid by using a motor servo control and an excitation current control of the excitation synchronous generator.

### BACKGROUND OF THE INVENTION

Generally, in a wind power generation system with a permanent magnet generator or an induction generator, the energy of a power source is transmitted by using a transmission mechanism to transmit a rotational energy to a generator. A rotation speed and a torque of the generator are determined according to the magnitude of the power source. Therefore, the rotation speed thereof is required to be limited for ensuring that the rotation speed varies in a specific range. When the energy of the power source is higher or lower than a standard range, the generator is turned off until the energy of the power source is in the standard range. In this passive power generation system, an AC-to-DC converter and a DC-to-AC converter are required to output the energy of the power source. However, this converting method will result in a power loss of the energy conversion, hence deteriorating an energy conversion efficiency and increasing the cost of the generation equipment.

Besides, in the induction wind generator, when the inputted power source is altered, or when the load of the utility grid is raised, the induction generator can not control the excitation current thereof. Thus, when the energy required for a load terminal is increased, a voltage from an output terminal of the generator can not be constant, resulting in a reduction of an output energy quality.

### SUMMARY OF THE INVENTION

Therefore, an aspect of the present invention is to provide a control method of an excitation synchronous generator for maximum power tracking. With use of a motor servo control and an excitation current control of the excitation synchronous generator, a rotation speed of a transmission mechanism can be adjusted. When an input rotation speed is too high or low due to a variation of a power source, such as wind power source, the motor servo control is used, so as to allow the transmission mechanism to rotate at a constant rotation speed, and to control the phase thereof. Therefore, the excitation synchronous generator can be rotated at a constant speed for stably outputting energy with a frequency and a phase. Moreover, a maximum power determining unit can integrate an energy input power and a motor fine tuning power for determining a power command, and can feed back an output power of the synchronous generator for generating an excitation current command to control an output voltage and a current of the excitation synchronous generator, so as to allow the excitation synchronous generator to obtain the maximum power.

In the present invention, with use of the motor servo control for frequency stabilization and an excitation current control of the excitation synchronous generator for maximum power tracking, when the input of the power source of the power generation system varies, the output of the transmission mechanism can be stabilized for controlling the voltage, frequency and phase thereof. Furthermore, by using a power feedback and an excitation current control, the power generation system can generate the maximum power to a utility grid load.

According to a preferred embodiment of the present invention, the control method of the wind power excitation synchronous generation system comprises the following steps: detecting an output voltage, a current and a power of the excitation synchronous generator; controlling an excitation current of the excitation synchronous generator according to the output voltage, the current and the power, so as to allow the excitation synchronous generator to output a maximum power to a utility grid load; and performing a servo control of a motor according to an information of an encoder, so as to allow a transmission mechanism to drive the excitation synchronous generator at a predetermined speed, thereby generating a three-phase alternating-current (AC) power supply with a phase equal to the utility grid load, wherein the three-phase AC power supply is allowed to be connected to the utility grid load in parallel.

In one embodiment of the present invention, the control method further comprises the following steps: when the energy of the power source decreases, raising a duty cycle of the motor according to the information of the encoder, so as to drive the motor to follow a position command based on a utility grid phase, and providing a fine tuning power to maintain the excitation synchronous generator at a constant rotation speed, and simultaneously adjusting an excitation current of an excitation controlling unit for reducing the excitation current of the excitation synchronous generator, hence reducing the fine tuning power which is used to drive the excitation synchronous generator by the motor and outputting the maximum power to the utility grid load.

In one embodiment of the present invention, the control method further comprises the following steps: when the energy of the power source increases, reducing a duty cycle of the motor according to the information of the encoder, so as to drive the motor to follow a position command based on a utility grid phase for maintaining the excitation synchronous generator at a constant rotation speed, and simultaneously adjusting an excitation current of an excitation controlling unit for raising the excitation current of the excitation synchronous generator and outputting the maximum power to the utility grid load.

According to another embodiment of the present invention, the wind power excitation synchronous generation system comprises: a wind power source; an excitation synchronous generator; a transmission mechanism configured to use a wind energy of the wind power source to drive the excitation synchronous generator; an excitation controlling unit configured to provide an excitation current signal to the excitation synchronous generator, so as to allow the excitation synchronous generator to output an electric energy to the utility grid load; a motor configured to control the driving of the transmission mechanism; a digital signal processing controller configured to determine a duty cycle width of a pulse width modulation (PWM) controlling unit according to a phase information of the utility grid and a position information of an armature of the excitation synchronous generator; and a power driving inverter configured to receive a power switch timing transmitted form the PWM controlling unit for driving the motor.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing a system using the control method of a wind power excitation synchronous generation system according to an embodiment of the present invention;

FIG. 2 is a block diagram showing a maximum power determining unit according to the embodiment of the present invention; and

FIG. 3 is a block diagram showing an output current of the excitation synchronous generator and a power feedback control according to the embodiment of the present invention.

### DETAILED DESCRIPTION OF THE PREFERRED EMBODIMENT

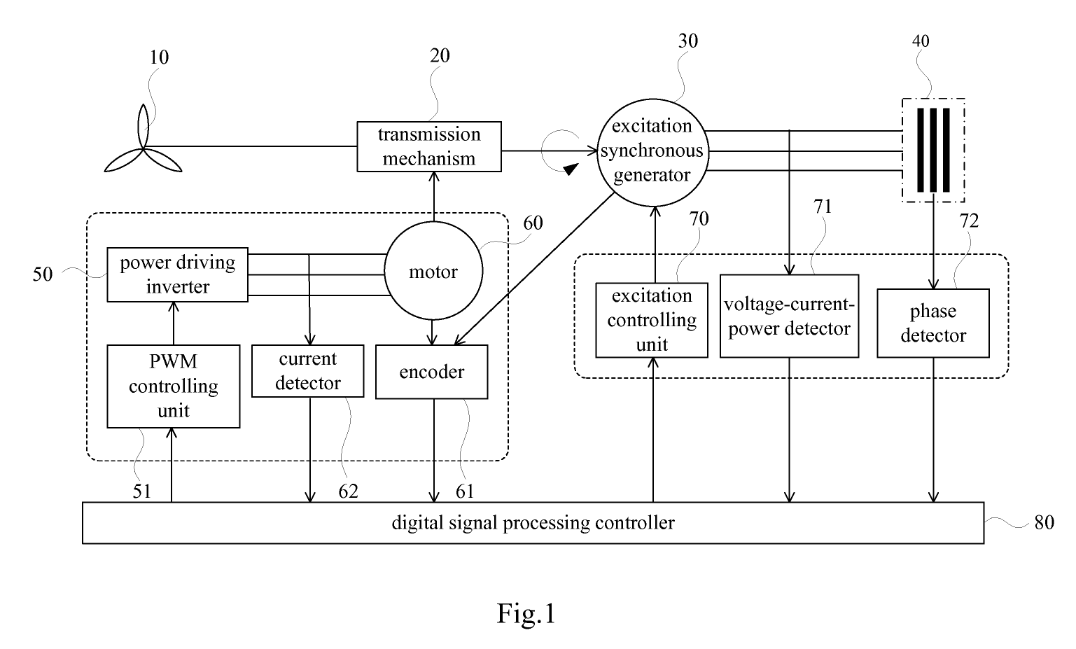

In order to make the illustration of the present invention more explicit and complete, the following description is stated with reference to FIG. 1 through FIG. 3.

In the drawings, like reference numerals indicate like components or items.

Referring to FIG. 1, a schematic diagram showing a system using the control method of a wind power excitation synchronous generation system according to an embodiment of the present invention is illustrated. The method of the present invention can be applicable to a wind power generation system which is described below. However, the method may be applicable to other power systems, such as waterpower, firepower and tidal power system, but not limited to the above description. The present invention can be used for a control technique of a renewable energy relating to any power generation systems.

Referring to FIG. 1 again, the generation system of the present invention can comprise a wind power source (power source) 10, a transmission mechanism 20, an excitation synchronous generator 30, a utility grid load 40, a power driving inverter 50, a pulse width modulation (PWM) controlling unit 51, a motor 60, an encoder 61, a current detector 62, a excitation controlling unit 70, a voltage-current-power detector 71, a phase detector 72 and a digital signal processing controller 80.

Referring to FIG. 1 again, when the energy of the power source 10 is inputted, the transmission mechanism 20 drives the excitation synchronous generator 30 to work by inputting for example a wind energy provided from the wind power source 10. The excitation controlling unit 70 provides an excitation current signal, so as to allow the excitation synchronous generator 30 to generate an electrical energy outputted to the utility grid load 40.

Referring to FIG. 1 again, the encoder 61 transmits a position information of the excitation synchronous generator 30 to the digital signal processing controller 80. The digital signal processing controller 80 uses the phase detector 72 to obtain a phase information of the utility grid as a present position command for comparing with the position information of an armature of the excitation synchronous generator 30, so as to determine a duty cycle width of the PWM controlling unit 51, and to output a power switch timing to the power driving inverter 50 for driving the motor 60. With use of the position servo control of the motor, the transmission mechanism 20 can drive the excitation synchronous generator 30 at a constant speed. Therefore, the frequency of the voltage outputted by the generator 30 can be stable, and the phase of the outputted voltage is equal to the utility grid. When the excitation synchronous generator 30 works, a signal fed from the voltage-current-power detector 71 is used to detect the voltage, current and power of the excitation synchronous generator 30. According to an information of the voltage-current-power detector 71, the digital signal processing controller 80 can provide an excitation current control to excitation controlling unit 70 for adjusting an excitation current of the generator, so as to allow the generator to output a constant voltage and current.

Referring to FIG. 1 again, when the energy of the wind power source 10 decreases, and the rotation speed of the transmission mechanism 20 slows down, for maintaining the rotation speed thereof, the digital signal processing controller 80 can adjust the PWM controlling unit 51 according to the information of the encoder 61 and the current detector 62, so as to raise a duty cycle of the motor and drive the motor 60 to follow the position command which is fed back by the phase detector 72 for reducing the position error and maintaining the excitation synchronous generator 30 at a constant rotation speed. At the same time, for maintaining the excitation synchronous generator 30 to rotate at the constant rotation speed, the digital signal processing controller 80 can adjust the excitation current of the excitation controlling unit 70 for reducing the excitation current of the generator, hence reducing a fine tuning power which is used to drive the generator by the motor 60.

Referring to FIG. 1 again, when the energy of the wind power source 10 increases, and the rotation speed of the transmission mechanism 20 speeds up, for maintaining the rotation speed thereof, the digital signal processing controller 80 can adjust the PWM controlling unit 51 according to the information of the encoder 61 and the current detector 62, so as to reduce the duty cycle of the motor and drive the motor 60 to follow the position command which is fed back by the phase detector 72 for reducing the position error and maintaining the excitation synchronous generator 30 at a constant rotation speed. At the same time, since the energy of the wind power source 10 increases resulting in a rise of the rotation speed, for maintaining the excitation synchronous generator 30 to rotate at the constant rotation speed, the digital signal processing controller 80 can adjust the excitation current of the excitation controlling unit 70 for raising the excitation current of the generator, hence completely using the inputted energy of the wind power source 10 to drive the generator. Thus, the generator can output a maximum power to the utility grid load 40.

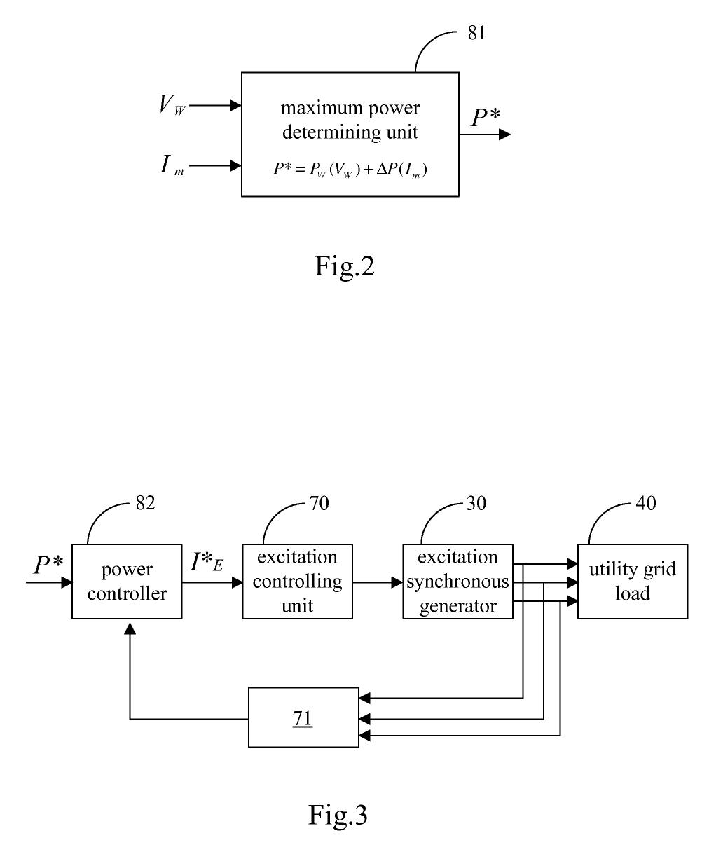

Referring to FIG. 2, the power generation system further comprises a maximum power determining unit 81 which determines a maximum power of the power generation system according to a wind energy input power P_{W}(V_{W}) and a motor fine tuning power ΔP(Iₘ), i.e. P_{W}(V_{W})+ΔP(Iₘ). The wind energy input power P_{W}(V_{W}) is determined according to a wind speed (V_{W}) so as to allow the outputted power of the motor to follow it. For raising the efficiency of the power generation system, the outputted power thereof is required to follow the wind energy input power, and it is also required to reduce the energy used by the motor, so as to achieve a constant speed control. Therefore, a motor input current (Iₘ) detected, and the motor input current is preferably close to zero for generating the motor fine tuning power ΔP(Iₘ). A power command P* for maximum power tracking is provided to the generator according to the sum [P_{W}(V_{W})+ΔP(Iₘ)] of the wind energy input power and the motor fine tuning power, and the excitation current control is performed to achieve the maximum power tracking of the generator.

Referring to FIG. 3, the power command P* is generated by the maximum power determining unit 81. The maximum power determining unit 81 uses the power detector 71 to obtain a real-time output power information P_{O} from the output terminal of the motor, and feed back this information to compare with the power command. A power controller 82 can generate an excitation current command I_{E} to the excitation controlling unit 70, and thus the excitation controlling unit 70 can generate an excitation current I_{E} for controlling an excitation field of the excitation synchronous generator 30, so as to allow the generator to generate the maximum power to the utility grid load 40.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A control method of a wind power excitation synchronous generation system for maximum power tracking, wherein the control method comprises the following steps:
detecting an output voltage, a current and a power of the excitation synchronous generator;
controlling an excitation current of the excitation synchronous generator according to the output voltage, the current and the power, so as to allow the excitation synchronous generator to output a maximum power to a utility grid load; and
performing a servo control of a motor according to an information of an encoder, so as to allow a transmission mechanism to drive the excitation synchronous generator at a predetermined speed, thereby generating a three-phase alternating-current (AC) power supply with a phase equal to the utility grid load, wherein the three-phase AC power supply is allowed to be connected to the utility grid load in parallel.

2. The control method as claimed in claim 1, further comprising the following steps:
when the energy of the power source decreases, raising a duty cycle of the motor according to the information of the encoder, so as to drive the motor to follow a position command based on a utility grid phase, and providing a fine tuning power to maintain the excitation synchronous generator at a constant rotation speed, and simultaneously adjusting an excitation current of an excitation controlling unit for reducing the excitation current of the excitation synchronous generator, hence reducing the fine tuning power which is used to drive the excitation synchronous generator by the motor and outputting the maximum power to the utility grid load.

3. The control method as claimed in claim 1, further comprising the following steps:
when the energy of the power source increases, reducing a duty cycle of the motor according to the information of the encoder, so as to drive the motor to follow a position command based on a utility grid phase for maintaining the excitation synchronous generator at a constant rotation speed, and simultaneously adjusting an excitation current of an excitation controlling unit for raising the excitation current of the excitation synchronous generator and outputting the maximum power to the utility grid load.

4. A wind power excitation synchronous generation system, comprising:
a wind power source;
an excitation synchronous generator;
a transmission mechanism configured to use a wind energy of the wind power source to drive the excitation synchronous generator;
an excitation controlling unit configured to provide an excitation current signal to the excitation synchronous generator, so as to allow the excitation synchronous generator to output an electric energy to the utility grid load;
a motor configured to control the driving of the transmission mechanism;
a digital signal processing controller configured to determine a duty cycle width of a pulse width modulation (PWM) controlling unit according to a phase information of the utility grid and a position information of an armature of the excitation synchronous generator; and
a power driving inverter configured to receive a power switch timing transmitted form the PWM controlling unit for driving the motor.
